(19) United States
(12) Patent Application Publication
(10) Pub. No.: US 2005/0120505 A1
(43) Pub. Date: Jun. 9, 2005

(54) Self-directed dust cleaner

(75) Inventor: Takao Tani, Osaka (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 10/983,897

(22) Filed: Nov. 9, 2004

(30) Foreign Application Priority Data
Nov. 10, 2003 (JP) 2003-379361
Jan. 9, 2004 (JP) 2004-004161

(51) Int. Cl. A47L 5/00

(52) U.S. Cl. 15/319

(57) ABSTRACT

In a self-directed dust cleaner with surveiling function, when an object sensor senses existence of an object supposed as an intruder, a main controller controls that a driving apparatus to rotate a movable body to orient a lens of an imaging apparatus to the object. The imaging apparatus takes a picture image including the object, and an image data outputted from the imaging apparatus is transmitted to a telephone communication apparatus via a wireless LAN and a LAN cable. The telephone communication apparatus calls a mobile equipment of a user so as to transmit the image data taken by the imaging apparatus. Judgment whether unusual situation such as an intruder has occurred or not is entrusted to the user, so that an algorithm executed in the main controller becomes simple.

### BACKGROUND OF THE INVENTION

1. Field of the Invention

The present invention relates to a self-directed dust cleaner having surveiling function, which can automatically collect dust on a floor while it moves on the floor in self-directed, and can surveil an empty house.

2. Description of the Related Art

Conventionally, it is considered to add a function for surveiling an empty house to a self-directed dust cleaner (self-propelled cleaner for home use). In a first conventional self-directed dust cleaner, for example, shown in the laid open publication of Japanese patent application 11-2882533, when a visual sensor senses unusual situation during an automatic dust collecting operation of the self-directed dust cleaner, a CCD camera takes a picture image of environment. Subsequently, the self-directed dust cleaner moves to an information station so that an image data of the picture image taken by the CCD camera is transmitted to a mobile equipment of a user via the information station.

In a second conventional self-directed dust cleaner shown in the laid open publication of Japanese patent application 2002-92761, an image data taken by a CCD camera is compared with another image data of normal situation previously taken so as to sense the occurrence of unusual situation. When the occurrence of the unusual situation is sensed, information showing the occurrence of the unusual situation is transmitted to a user via a house server.

In a third conventional self-directed dust cleaner shown in the laid open publication of Japanese patent application 2002-92762, an image data taken by an image sensor and other signals sensed by a thermo-sensor, a smoke-sensor, a gas-sensor, and so on are transmitted to a battery charger of the self-directed dust cleaner by wireless transmission. A judger provided in the battery charger judges whether unusual situation has occurred or not with using the transmitted data. When the judger senses the occurrence of the unusual situation, information showing the occurrence of the unusual situation is transmitted to a user.

The above-mentioned conventional self-directed dust cleaners are respectively constituted for judging the occurrence of the unusual situation themselves with using the image data taken by the image sensor. Thus, they have disadvantages that not only a capacity of a memory such as a RAM (random access memory) necessary for processing image data becomes much larger, but also an algorithm for judging the occurrence of the unusual situation becomes complex. Consequently, the cost for manufacturing the self-directed dust cleaner becomes much higher, so that it is difficult to put the self-directed dust cleaner with the surveiling function of the empty house into practical use.

Furthermore, the conventional self-directed dust cleaners have still another disadvantage that battery consumption becomes larger due to the image sensing process of the image sensor and the data processing of the image data taken by the image sensor. Thus, it is necessary to prepare a battery of large capacity for continuous duty at length, so that it is difficult to reduce the cost of the self-directed dust cleaner.

Still furthermore, the first conventional self-directed dust cleaner has a disadvantage that it is impossible to inform the occurrence of the unusual situation to the user, if the intruder overturns the self-directed dust cleaner while the self-directed dust cleaner moves to the information station.

### SUMMARY OF THE INVENTION

A purpose of the present invention is to provide a self-directed dust cleaner, which can carry out the surveiling of the intruder in the empty house, at a low cost.

A self-directed dust cleaner in accordance with an aspect of the present invention comprises a movable body, a driving apparatus for moving the movable body on a floor, a dust collection apparatus for collecting dust on the floor, an imaging apparatus for taking a picture image of environment of the movable body, a telephone communication apparatus for communicating with a telephone exchanger via a telephone line, at least an object sensor for sensing an existence of an object and a main controller for controlling each element of the dust cleaner.

When the object sensor senses the existence of an object, the main controller controls the elements in a manner so that the driving apparatus moves the movable body for orientating the imaging apparatus to a direction in which the object sensor senses the existence of the object, the imaging apparatus takes a picture image, and the telephone communication apparatus transmits an image data of the picture image taken by the imaging apparatus to a mobile equipment of a user or a display apparatus of a security company.

By such a configuration, the main controller has no function for judging whether unusual situation such as intrusion of an intruder occurs or not, and the judgment of the occurrence of the unusual situation is entrusted to the user or the security company. Thus, an algorithm of the main controller becomes simple, so that a relatively inexpensive low-speed processor can be used as an element of the main controller. Consequently, the self-directed dust cleaner with surveiling function of the intruder in the empty house can be provided a low cost. Furthermore, the power consumption of the main controller can be reduced, so that the surveiling function of the intruder in the empty house can be maintained at length.

### BRIEF DESCRIPTION OF THE DRAWINGS

FIG. 1 is a plan view showing a layout of a house and an arrangement of components of a self-directed dust cleaner in accordance with an embodiment of the present invention;

FIG. 2 is a conceptual diagram showing a configuration and an operation of the self-directed dust cleaner when it senses an intruder;

FIG. 3 is a block diagram showing a configuration of a movable body of the self-directed dust cleaner;

FIG. 4A is a plan view showing an example that the movable body senses an intruder;

FIG. 4B is a plan view showing an example that the movable body takes a picture image of the intruder; and

FIG. 5 is a flowchart showing an operation of the self-directed dust cleaner in a security surveiling mode.

### DETAILED DESCRIPTION OF THE EMBODIMENT

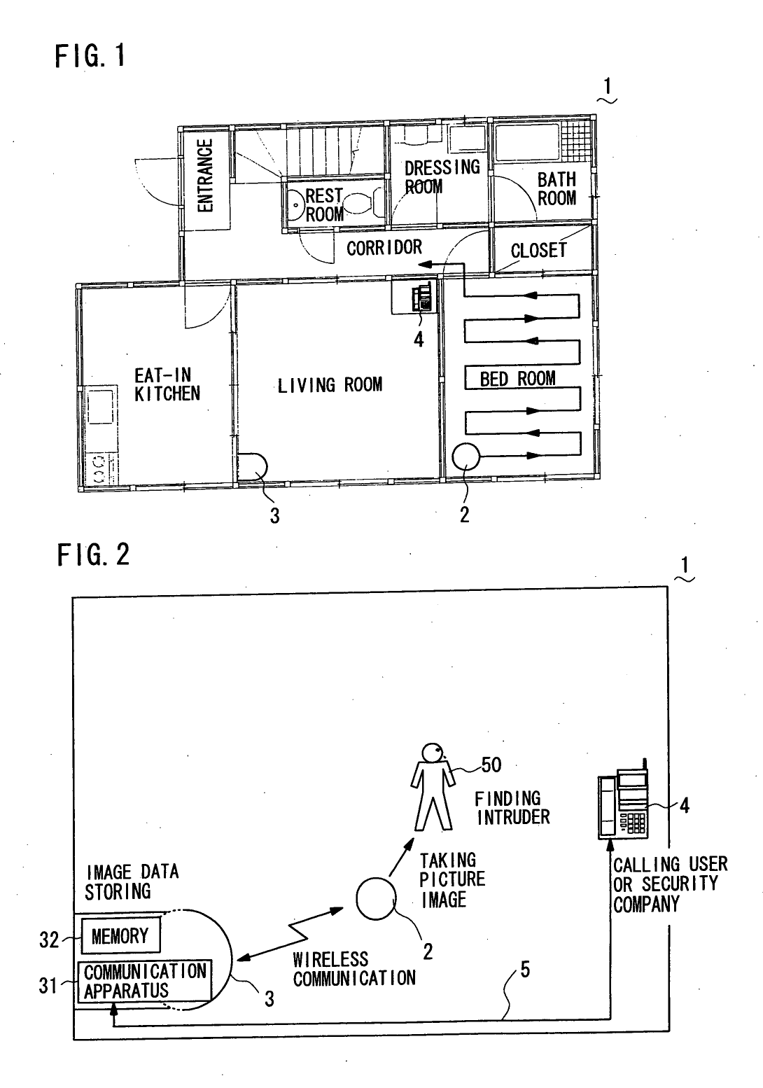

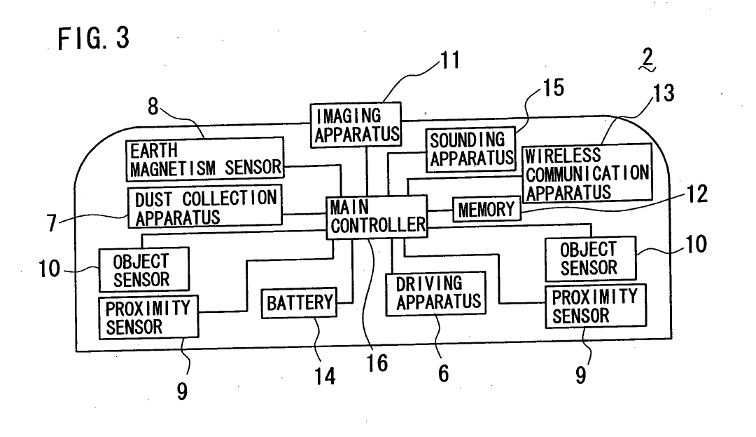

A self-directed dust cleaner in accordance with an embodiment of the present invention is described. FIG. 1 shows a layout of a house and an arrangement of components of the self-directed dust cleaner 1. The self-directed dust cleaner 1 is configured by a movable body 2 for collecting dust on a floor while it moves in the house, a battery charger 3 for charging a secondary battery 14 (see FIG. 3) embedded in the movable body 2, and a telephone communication apparatus (telephone equipment) 4 for communicating with a nearest telephone exchanger via a telephone line. The battery charger 3 and the telephone communication apparatus 4 are respectively provided stationary at a predetermined position in a house.

The self-directed dust cleaner 1 has an automatic dust collection mode in which the movable body 2 collects the dust on the floor while it moves on the floor by automatic control, a security surveiling mode for surveiling an intruder, and so on. A user can optionally select one operation mode among a plurality of the operation modes.

FIG. 2 shows an operation of the self-directed dust cleaner 1 when it senses an intruder. In the security surveiling mode, the movable body 2 is stopped at an optional position on a floor for surveiling intrusion of an intruder into an empty house. When the an object which is supposed as the intruder is sensed, a picture image of environment of the movable body 2 is taken, and an image data of the picture image is transmitted to a mobile equipment such as a mobile phone of a user away from house. The battery charger 3 has a second wireless communication apparatus 31 for communicating with the movable body 2 via a wireless LAN (local area network) and a memory 32 for storing image data transmitted from the movable body 2. The battery charger 3 is connected to the telephone communication apparatus 4 via a LAN cable 5. The image data of the picture image taken by the movable body 2 is transmitted to the second wireless communication apparatus 31 via the wireless LAN and temporarily stored in the memory 32. The image data stored in the memory 32 is further transmitted to the telephone communication apparatus 4 via the LAN cable 5. The telephone communication apparatus 4 still further transmits the image data to the mobile equipment of the user via the telephone line. Thus, the user can watch the picture image in the house, and judge whether the unusual situation has been occurred or not. It is possible to transmit the image data of the picture image taken by the movable body 2 to a security company instead of the mobile equipment of the user. Furthermore, the memory 32 can store the image data at length, so that it is possible to use the picture image, which is a reproduction of the image data, as an evidence of the intrusion. Still furthermore, even if the intruder awakes that the picture image was taken and he vandalizes the movable body 2, the image data stored in the memory 32 of the battery charger 3 may not be damaged.

FIG. 3 shows a block configuration of the movable body 2. The movable body 2 has a driving apparatus 6 for moving on a floor of a house, a dust collection apparatus 7 for collecting dust on the floor, an earth magnetism sensor 8 serving as a position sensor for sensing a moving direction of the movable body 2, a plurality of proximity sensors 9 serving as an obstacle sensor for sensing that the movable body 2 approaches to an obstacle, a plurality of object sensors 10 for sensing an existence of an object in the environment of the movable object 2, an imaging apparatus 11 for taking a picture image of the environment of the movable body 2, a memory 12 for storing an image data of the picture image taken by the imaging apparatus 11, a first wireless communication apparatus 13 for transmitting the image data to the second wireless communication apparatus 31 of the battery charger 3, a sounding apparatus 15 for generating a threatening sound to the intruder as occasion demands, a main controller 16 for controlling the above-mentioned elements, and the above-mentioned secondary battery 14 for supplying electric power to the elements.

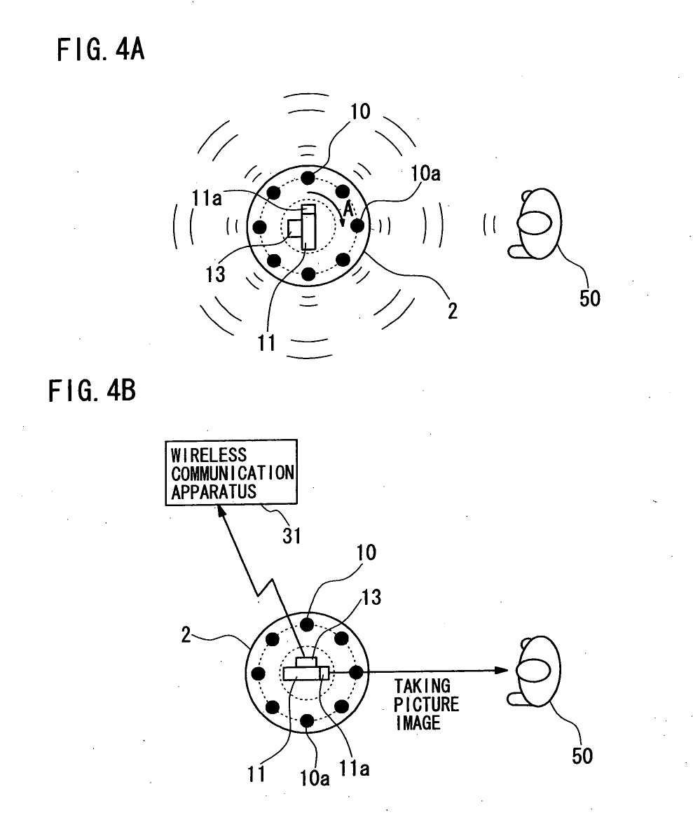

The imaging apparatus 11 is stationary provided on the movable body 2, so that a mounting structure of the imaging apparatus 11, a wiring to an imaging device, and so on become simple. Thus, the movable body 2 can be downsized and the cost of the self-directed dust cleaner 1 can be reduced. It, however, is necessary to move the movable body 2 for changing the orientation of a lens 1 la (see FIGS. 4A and 4B) of the imaging apparatus 11.

The proximity sensors 9 are provided on outer peripheries of the movable body 2 so as to sense existence of an obstacle in the vicinity of the movable body 2. The main controller 16 is constituted by, for example, a CPU (central processing unit) for processing several processes corresponding to a control program, a ROM (read only memory) for memorizing the control program and so on, and a RAM (random access memory) for memorizing control data and so on, temporality. The main controller 16, which serves as a navigation apparatus, controls the driving apparatus 6 so as to move the movable body 2 along a predetermined route with using output signals from the earth magnetism sensor 8 and the proximity sensors 9. Thus, the movable body 2 can move on the floor in self-directed with clearing the obstacles, for example, in the automatic dust collection mode.

The object sensors 10 are, for example, infrared sensors for sensing infrared rays emitted from an object such as a human body. In an example shown in FIGS. 4A and 4B, eight object sensors are provided on a circle at a predetermined angular interval in the vicinity of an outer periphery of the movable body 2, so that an object existing in the environment of the movable body 2 can be sensed.

The first wireless communication apparatus 13, the second wireless communication apparatus 31 and the telephone communication apparatus 4 serve as an image data transmitting apparatuses to the mobile equipment of the user.

FIGS. 4A and 4B show an example that the movable body 2 senses an intruder and takes a picture image of him in the security surveiling mode. As shown in FIG. 4A, when the intruder 50 approaches to the movable body 2, which is stopped at a predetermined position, infrared rays emitted from the human body of the intruder 50 is sensed by, for example, the object sensor 10a facing the intruder 50. Thus, it is possible to suppose that an object such as a human body exists in a direction of the object sensor 10a. At the point of sensing the object, it is unclear whether the object is the intruder or not. There is a possibility that the object sensed by the object sensor 10a is, for example, an animal companion. Accordingly, the picture image of the object is taken as following processes, and the image data of the picture image is transmitted to the mobile equipment of the user. The judgment whether unusual situation has occurred or not is entrusted to the user.

When the object sensor 10a senses the existence of the object such as the intruder 50, the main controller 16 drives the driving apparatus 6 for rotating the movable body 2 in, for example, clockwise direction shown by arrow A so as to orient the lens 11a of the imaging apparatus 11 to the direction facing the intruder 50 in which the object sensor 10a was oriented, as shown in FIG. 4B. Subsequently, the imaging apparatus 11 takes a picture image of the environment of the movable body 2 in the orientation of the imaging apparatus 11. The image data of the picture image taken by the imaging apparatus 11 is transmitted from the first wireless communication apparatus 13 of the movable body 2 to the second wireless communication apparatus 31 of the battery charger 3. The image data transmitted to the second wireless communication apparatus 31 is stored in the memory 32, and further transmitted to the mobile equipment of the user via the LAN cable 5 and the telephone communication apparatus 4. The user can judge whether the intruder 50 has intruded in the empty house or not by confirming the picture image displayed on the mobile equipment with using the transmitted image data. If the intruder 50 has intruded in the empty house, the user can have a proper and necessary action, for example, calling up the security company, or remote controlling the movable body 2 for outputting a threatening sound to the intruder by the sounding apparatus 15 so as to force the intruder out of the house.

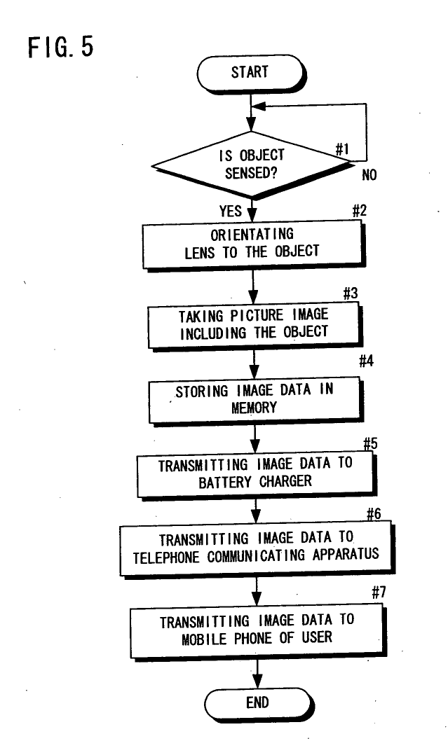

Subsequently, the operation of the self-directed dust cleaner 1 in the security surveiling mode is described with reference to a flowchart show in FIG. 5. When an object which is supposed as an intruder is sensed (YES in step #1), the driving apparatus 6 is driven for orientating the lens 11a of the imaging apparatus 11 to the object (#2), and a picture image including the object is taken by the imaging apparatus 11 (#3). The image data outputted from the imaging apparatus 11 is temporarily stored in the memory 12 (#4), and the image data is transmitted to the second wireless communication apparatus 31 of the battery charger 3 by the first wireless communication apparatus 13 (#5). The second wireless communication apparatus 31 stores the image data into the memory 32 and further transmits the image data to the telephone communication apparatus 4 (#6). The telephone communication apparatus 4 calls the mobile equipment of the user so as to transmit the image data to the mobile equipment such as a mobile phone (#7). When the image data is transmitted to the mobile equipment of the user, the operation in the security surveiling mode is completed.

As mentioned above, the self-directed dust cleaner 1 in accordance with the embodiment has no function for judging whether the unusual situation occurs or not, and the judgment of the occurrence of the unusual situation is entrusted to the user. Thus, it is possible to surveil the empty house with making the algorithm executed in the main controller 16 simple. Since the algorithm in the main controller 16 becomes simple, it is possible to use an inexpensive low-speed processor as an element of the main controller 16. Furthermore, the main controller 16 does not process the image data taken by the imaging apparatus 11, so that it is possible to make the capacity of the RAM constituting the main controller 16 much smaller than that of the conventional self-directed dust cleaner with the surveiling function. Consequently, the self-directed dust cleaner with surveiling function can be supplied at low price. Still furthermore, relatively inexpensive infrared sensors are used as the object sensors 10, so that the cost for manufacturing the self-supporter dust cleaner can be reduced.

Additionally, the self-directed dust cleaner in accordance with the embodiment has the automatic dust collection mode and the security surveiling mode, which can alternatively be selected. When the security surveiling mode is selected, the movable body 2 is essentially stopped at a predetermined position, and the driving apparatus 6 rotates the movable body 2 in a manner so that the lens 11a of the imaging apparatus 11 orientates the object sensed by the object sensors 10, so that the power consumption can be reduced in the security surveiling mode. Consequently, it is possible to surveil the empty house at length, even when a small capacity of the secondary battery 14 is used. Similarly, when the automatic dust collection mode is selected in which the driving apparatus 6 and the dust collection apparatus 7 consume the electric power largely, it is possible to switch off the object sensors 10, the imaging apparatus 11, the first wireless communication apparatus 13 and so on which are necessary for only the security surveiling mode. Alternatively, it is possible to carry out the security surveiling mode simultaneously, while the automatic dust collection mode is carried out. In such a case, it is possible that the security surveiling mode is intermittently carried out and the movement of the movable body 2 and the dust collection apparatus 7 are suspended briefly, while the security surveiling mode is carried out.

This application is based on Japanese patent applications 2003-379361 filed Nov. 10, 2003 and 2004-4161 filed Jan. 9, 2004 in Japan, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

1. A self-directed dust cleaner comprising:
a movable body; a driving apparatus for moving the movable body on a floor;
a dust collection apparatus for collecting dust on the floor;
an imaging apparatus for taking a picture image of environment of the movable body;
a telephone communication apparatus for communicating with a telephone exchanger via a telephone line;
at least an object sensor for sensing an existence of an object; and
a main controller for controlling each element of the dust cleaner; wherein
when the object sensor senses existence of an object, the main controller controls the elements in a manner so that the driving apparatus moves the movable body for orientating the imaging apparatus to a direction in which the object sensor senses the existence of the object, the imaging apparatus takes a picture image, and the telephone communication apparatus transmits an image data of the picture image taken by the imaging apparatus to a mobile equipment of a user.

2. The self-directed dust cleaner in accordance with claim 1 further comprising:
a pair of wireless communication apparatuses used for transmitting the image data to the telephone communication apparatus.

3. The self-directed dust cleaner in accordance with claim 2 further comprising:
a battery charger stationary disposed at a predetermined position in a house and used for charging a secondary battery provided on the movable body; and wherein
one of the wireless communication apparatuses is provided on the movable body, and the other is provided on the battery charger; and the battery charger and the telephone communication apparatus is connected by a LAN cable.

4. The self-directed dust cleaner in accordance with claim 3, wherein
the battery charger further has a memory into which the image data is stored.

5. The self-directed dust cleaner in accordance with claim 1, wherein
the object sensor is an infrared sensor for sensing infrared rays emitted from the object.

6. The self-directed dust cleaner in accordance with claim 5, wherein
a plurality of the infrared sensors is provided on a circle at a predetermined angular interval in a vicinity of an outer periphery of the movable body.

7. The self-directed dust cleaner in accordance with claim 1, wherein
the main controller operates an automatic dust collection mode and a security surveiling mode that can alternatively be selected;
when only the security surveiling mode is selected, the movable body is stopped at a predetermined position on a floor of a house; and
when the object sensor senses the existence of the object, the driving apparatus rotates the movable body at the position.

8. The self-directed dust cleaner in accordance with claim 1, wherein
when both of the automatic dust collection mode and the security surveiling mode are simultaneously selected, the security surveiling mode is intermittently carried out and the movement of the movable body and the dust collection apparatus are suspended briefly, while the security surveiling mode is carried out.

9. The self-directed dust cleaner in accordance with claim 1 further comprising:
a sounding apparatus for generating a threatening sound to the object corresponding to a remote control of the user.

10. A self-directed dust cleaner comprising:
a movable body;
a moving means provided on the movable body for moving the movable body on a floor of a house in self-directed;
a dust collection means provided on the movable body for collecting dust on the floor while moving on the floor;
a position sensing means for sensing a position of the movable body on the floor;
an obstacle sensor for sensing obstacles;
a navigation means for controlling moving direction of the movable body on the floor with clearing the obstacles;
an object sensing means provided on the moving body for sensing an object, which can be supposed as an intruder;
an image taking means provided on the moving body for taking a picture image including the object when the object sensing means senses the object;
a memory means for storing an image data outputted from the image taking means; and
an image data transmitting means for transmitting the image data outputted from the image taking means to a mobile equipment of a user.

11. The self-directed dust cleaner in accordance with claim 10, wherein
the image data transmitting means has a telephone communication means separately provided from the movable body for calling the mobile equipment of the user and a wireless data transmitting means for transmitting the image data from the movable body to the telephone communication means.

12. The self-directed dust cleaner in accordance with claim 10, wherein
the object sensing means senses infrared rays emitted from the object.

13. The self-directed dust cleaner in accordance with claim 10, wherein
when the object sensing means senses an object, the moving means and the dust collection means are stopped or suspended operation thereof.

14. The self-directed dust cleaner in accordance with claim 13, wherein
when the object sensing means senses an object, the moving means moves the movable body in a manner so that the image taking means can take the picture image including the object.
